(19) United States
(12) Patent Application Publication
(10) Pub. No.: US 2007/0096923 A1
(43) Pub. Date: May 3, 2007

(54) Voltage multiplier for radio frequency identification tags

(75) Inventors: Sang Kyun Lee, Gwangju (KR); Seong Su Park, Daejeon (KR); Kyung Hwan Park, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/448,468

(22) Filed: Jun. 6, 2006

(30) Foreign Application Priority Data
Nov. 3, 2005 (KR) 2005-104957

(51) Int. Cl. G08B 13/14; G06K 19/06

(52) U.S. Cl. 340/572.8; 235/492

(57) ABSTRACT

Provided is a voltage multiplier converting an alternating current (AC) electromagnetic wave into a direct current (DC) voltage signal in a radio frequency identification (RFID) tag, and including means for obtaining voltage gain, the means being connected to an input terminal through which the AC electromagnetic wave is input. The voltage multiplier can generate a greater DC output voltage than a conventional voltage multiplier at the same input power. Therefore, a desired DC output voltage can be obtained at low input power, so that an effective operating distance can be increased. In addition, since the voltage multiplier is easily integrated into a tag chip using a complementary metal-oxide semiconductor (CMOS) process, the size of the tag does not increase and it is easy to package an antenna and the tag chip.

### CROSS-REFERENCE TO RELATED APPLICATION

This application claims priority to and the benefit of Korean Patent Application No. 2005-104957, filed on Nov. 3, 2005, the disclosure of which is incorporated herein by reference in its entirety.

### BACKGROUND

1. Field of the Invention

The present invention relates to a voltage multiplier that converts an alternating current (AC) electromagnetic wave into a direct current (DC) voltage signal, and more particularly, to a voltage multiplier that can be applied to a tag of a radio frequency identification (RFID) system.

2. Discussion of Related Art

Radio frequency identification (RFID) is a technology that reads information from a tag or writes information to a tag using a radio frequency (RF) and is used to identify, trace and manage goods, animals, persons and so forth to which a tag is attached. An RFID system comprises a tag or a transponder having unique identification information and attached to goods, persons or so forth; a reader for reading the identification information from the tag or writing information to the tag; an object database; a network; and so forth.

As illustrated in FIG. 1, a passive tag generally includes an antenna 10 that receives electromagnetic waves emitted from the reader, a voltage multiplier 20 that converts the AC electromagnetic wave received by the antenna 10 into a DC voltage signal, a tag electronic circuit 30 that modulates and demodulates the signal received from reader, and a memory. The voltage multiplier 20, the tag electronic circuit 30, and the memory can be manufactured as a tag chip 40.

In general, the voltage multiplier 20 in the passive tag includes stages composed of a capacitor and a diode. The number of the stages can be increased or decreased to obtain a voltage required by the tag electronic circuit 30.

However, the voltage multiplier 20 used in a conventional digital complementary metal-oxide semiconductor (CMOS) circuit has a drawback in that efficiency deteriorates when a frequency band increases. In order to solve this problem, a technique has been developed which offsets the effect of a parasitic capacitance, which largely affects the voltage multiplier in a high frequency band, or optimizes the layout of capacitors and diodes constituting the voltage multiplier to improve the characteristics of the voltage multiplier. However, it is still difficult to obtain an enough output voltage in a high frequency band and to embody the technique through a CMOS process. For example, RFID tags that are available in frequency bands of 900 MHz and 2.45 GHz have been developed, and the RFID tags have a short reading distance due to reduction of a DC output voltage in a frequency band of 2.45 GHz. In addition, it is difficult to obtain a stable effective operating distance at low input power since there is a great difference between DC output voltages, which correspond to the input power of the AC electromagnetic wave received through the antenna 10, depending on fabrication methods of the diode and the capacitor. In order to obtain the stable effective operating distance even at the low input power, a method has been developed which increases conversion efficiency using multiple antennas (See U.S. Pat. No. 6,400,274). However, increasing the number of antennas increases the size of a tag and makes it difficult to package the antennas and a tag chip.

### SUMMARY OF THE INVENTION

The present invention is directed to implementation of a voltage multiplier for radio frequency identification (RFID) tags, which is capable of providing stable efficiency in a high frequency band and a stable effective operating distance at low input power.

An aspect of the present invention provides a voltage multiplier which converts an alternating current (AC) electromagnetic wave into a direct current (DC) voltage signal, the voltage multiplier comprising means for obtaining voltage gain, the means being connected to an input terminal through which the AC electromagnetic wave is input.

The means for obtaining voltage gain may be an inductor that is connected to one of the input terminals in series.

The inductor may be made up of the line in a single turn shape made through a semiconductor process.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a block diagram illustrating a conventional radio frequency identification (RFID) tag;

FIG. 2 is a circuit diagram illustrating a voltage multiplier for RFID tags according to an exemplary embodiment of the present invention; and

FIG. 3 is a graph showing the output voltage characteristics of the voltage multiplier according to the present invention.

### DETAILED DESCRIPTION OF PREFERRED EMBODIMENTS

Hereinafter, an exemplary embodiment of the present invention will be described in detail. However, the present invention is not limited to the embodiments disclosed below, but can be implemented in various types. Therefore, the present embodiment is provided for complete disclosure of the present invention and to fully inform the scope of the present invention to those ordinarily skilled in the art.

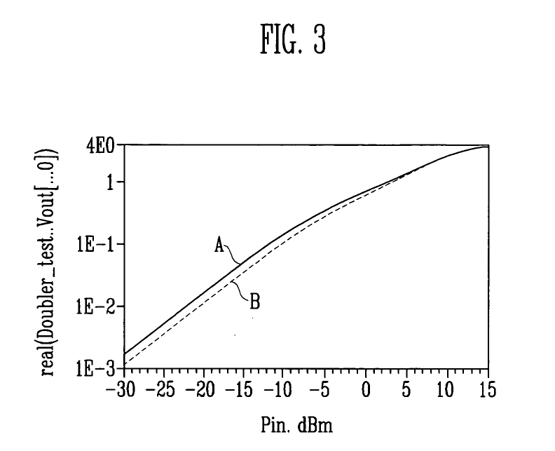

FIG. 2 is a circuit diagram illustrating a voltage multiplier for RFID tags, a structure of which is based on a Villard type voltage multiplier, according to an exemplary embodiment of the present invention.

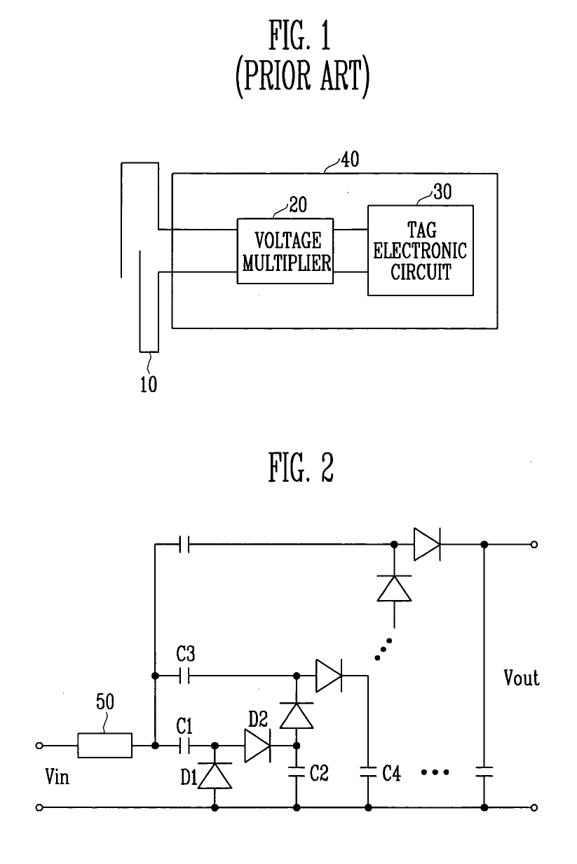

Referring to FIG. 2, a plurality of stages each composed of coupling capacitors C and diodes D are connected between input terminals Vin for receiving an alternating current (AC) electromagnetic wave from an antenna (10 in FIG. 1) and output terminals Vout for outputting a direct current (DC) voltage signal, and a device 50 that can provide voltage gain is connected to the input terminal Vin.

A Villard-type voltage multiplier generates a voltage of two times a ground voltage at a single output and may be connected in a cascade form to obtain a given output voltage. When the capacitors C1 and C2 are charged to one time and two times an input voltage, respectively, a pulsating DC voltage is obtained which pulsates between zero and two times the input voltage through diodes D1 and D2. The pulsating DC voltage is converted into an AC voltage by the capacitor C4 of the next stage, and the converted AC voltage is provided to the next stage as an input AC voltage.

Since the Villard type voltage multiplier composed of N stages generates an output voltage of 2N times an input voltage, any output voltage can be obtained by properly selecting the number of stages. This, however, is possible at neglectable current flow. When the output current flows, an AC current is generated through the capacitors. Thus, voltage drop appears as shown in Formula 1 below, lowering the input voltage of the next stage.

$$Δ V = \frac{I}{f c} ( \frac{2}{3} {n}^{3} + \frac{1}{2} {n}^{2} - \frac{1}{6} n ) \qquad Formula 1$$

Here, I denotes the output current, f denotes an input frequency, C denotes the capacitance, and n denotes the number of stages.

In the voltage multiplier according to the present invention, an inductor 50, which is capable of obtaining voltage gain, is connected to the input terminals Vin for receiving the AC electromagnetic wave, thereby obtaining a higher DC output voltage with respect to the same input power. The inductor may be made up of a line in a single turn shape, and may be integrated in a tag using a standard complementary metal-oxide semiconductor (CMOS) process or made as an external separate component. If the inductor is made using an uppermost metal layer to be integrated into the tag chip through the semiconductor process, it is possible to minimize the effect of a parasitic component without increasing the size of the tag chip.

Meanwhile, the voltage gain obtained by connecting the inductor 50, which is capable of obtaining the voltage gain, to the input terminal Vin for receiving the AC electromagnetic wave, in series, will be described.

While a typical antenna has an impedance of about 73 ohm, an antenna used in an RFID tag should be designed to have an impedance matched with the impedance of a tag chip. Most tag chips are made up of capacitors, and thus have large reactance values. The impedance and the capacitor form a resonance circuit to increase a DC output voltage. When an inductor is used to constitute the resonance circuit together with a capacitor, the inductor should be properly designed.

FIG. 3 is a graph showing the DC output voltage characteristics of the voltage multiplier according to the present invention, a DC output voltage being shown in a log scale at an operating frequency of 915 MHz according to input power.

It can be seen that the DC output voltage (line A) increased at low input power but was hardly changed at high input power. Considering the input power range of a radio frequency (RF) used in the tag of an RFID system, it can be seen that it is possible to obtain a greater DC output voltage (line A) than the DC output voltage (line B) of a conventional voltage multiplier at the same input power.

As described above, the voltage multiplier of the present invention can generate a greater DC output voltage than a conventional voltage multiplier with the same input power. Therefore, a desired DC output voltage can be obtained with low input power, and an effective operating distance can increase. In addition, since the voltage multiplier of the present invention can be easily integrated into a tag chip using a CMOS process, the size of the tag chip does not increase and it is easy to package an antenna and the tag chip.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A voltage multiplier for a radio frequency identification (RFID) tag converting an alternating current (AC) electromagnetic wave into a direct current (DC) voltage signal, the voltage multiplier comprising means for obtaining voltage gain, the means being connected to an input terminal through which the AC electromagnetic wave is input.

2. The voltage multiplier for a RFID tag according to claim 1, wherein the means for obtaining voltage gain is an inductor.

3. The voltage multiplier for a RFID tag according to claim 2, wherein the inductor is made up of a line in a single turn shape made through a semiconductor process.

4. The voltage multiplier for a RFID tag according to claim 1, wherein the means for obtaining voltage gain is connected to one of the input terminals in series.
